(19) United States
(12) Patent Application Publication
(10) Pub. No.: US 2025/0294344 A1
(43) Pub. Date: Sep. 18, 2025

(54) IMPROVED ROBUSTNESS FOR CONTROL PLANE IN SIXTH GENERATION FRONTHAUL

(71) Applicant: Telefonaktiebolaget LM Ericsson (publ), Stockholm (SE)

(72) Inventors: Eduardo LINS DE MEDEIROS, Bromma (SE); Igor ALMEIDA, Indaiatuba-SP (BR); Per-Erik ERIKSSON, Stockholm (SE); Gyanesh PATRA, Järfälla (SE)

(21) Appl. No.: 18/861,467

(22) PCT Filed: May 2, 2022
(86) PCT No.: PCT/SE2022/050422

§ 371 Date: Oct. 29, 2024

(51) Int. Cl. H04W 8/30; H04L 43/0829; H04W 72/1273

(52) U.S. Cl. CPC H04W 8/30; H04L 43/0829; H04W 72/1273

(57) ABSTRACT

A transmitting node in a fronthaul communications network that includes a receiving node, can determine that a loss has occurred in the fronthaul communications network between the transmitting node and the receiving node. Responsive to determining that the loss has occurred, the transmitting node can determine to duplicate control plane, CP, messages being transmitted toward the receiving node based on a redundancy factor. The transmitting node can further schedule transmission of a CP message and a duplicate of the CP message toward the receiving node.

### TECHNICAL FIELD

The present disclosure is related to wireless communication systems and more particularly to improved robustness for control plane in sixth generation fronthaul.

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”)).

The adoption of packet-based links between base station nodes enables operators to achieve statistical multiplexing gains in their fronthaul infrastructure. This technology facilitates flexible deployments and enables different functional split architectures.

At the same time, introducing packet-based links and switching elements may lead to degradation of radio performance, when for example, packet losses, excessive queueing or packet delay variation occur.

### SUMMARY

In some embodiments, a method of operating a transmitting node in a fronthaul communications network that includes a receiving node is provided. The method includes determining that a loss has occurred in the fronthaul communications network between the transmitting node and the receiving node. The method further includes, responsive to determining that the loss has occurred, determining to duplicate control plane (“CP”) messages being transmitted toward the receiving node based on a redundancy factor. The method further includes scheduling transmission of a CP message and a duplicate of the CP message toward the receiving node.

In other embodiments, a method of operating a receiving node in a fronthaul communications network that includes a transmitting node is provided. The method includes receiving a control plane (“CP”) message from the transmitting node. The method further includes determining whether a duplicate of the CP message has previously been received by the receiving node. The method further includes, responsive to determining whether the duplicate of the CP message has previously been received, handling the CP message based on whether the duplicate of the CP message has previously been received.

In other embodiments, another method of operating a receiving node in a fronthaul communications network that includes a transmitting node is provided. The method includes receiving a data plane (“DP”) message from the transmitting node. The method further includes determining that a control plane (“CP”) message associated with the DP message has not been previously received by the receiving node. The method further includes transmitting a signal to the transmitting node indicating that the CP message has been lost. The method further includes storing the DP message in a buffer for a predetermined period of time.

In other embodiments, a transmitting node, a receiving node, a computer program, a computer program product, or a non-transitory computer-readable medium is provided for performing one of the methods above.

In some embodiments, the robustness of fronthaul interfaces to losses of CP messages can be improved. This can prevent package drops, which can improve message reliability, latency, and overall user experience.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5th generation (“5G”) network;

FIG. 2 is a block diagram illustrating an example of a fronthaul interface between a radio equipment controller (“REC”) and a radio equipment (“RE”) in accordance with some embodiments;

FIG. 3 is a flow chart illustrating an example of operations performed by a transmitting node in accordance with some embodiments;

FIG. 4 is a block diagram illustrating an example of duplicate control plane (“CP”) messages being transmitted in a burst during a transmission window in accordance with some embodiments;

FIG. 5 is a block diagram illustrating an example of duplicate CP messages being transmitted in a uniform distribution during a transmission window in accordance with some embodiments;

FIG. 6 is a block diagram illustrating an example of duplicate CP messages being transmitted in a random distribution during a transmission window in accordance with some embodiments;

FIG. 7 is a flow chart illustrating an example of operations performed by a receiving node once a data plane (“DP”) or CP message is received in accordance with some embodiments;

FIG. 8 is flow chart illustrating an example of operations performed by a transmitting node in accordance with some embodiments;

FIG. 9 is a flow chart illustrating an example of operations performed by a receiving node in accordance with some embodiments;

FIG. 10 is a block diagram of a communication system in accordance with some embodiments;

FIG. 11 is a block diagram of a user equipment in accordance with some embodiments

FIG. 12 is a block diagram of a network node in accordance with some embodiments;

FIG. 13 is a block diagram of a host computer communicating with a user equipment in accordance with some embodiments;

FIG. 14 is a block diagram of a virtualization environment in accordance with some embodiments; and

FIG. 15 is a block diagram of a host computer communicating via a base station with a user equipment over a partially wireless connection in accordance with some embodiments in accordance with some embodiments.

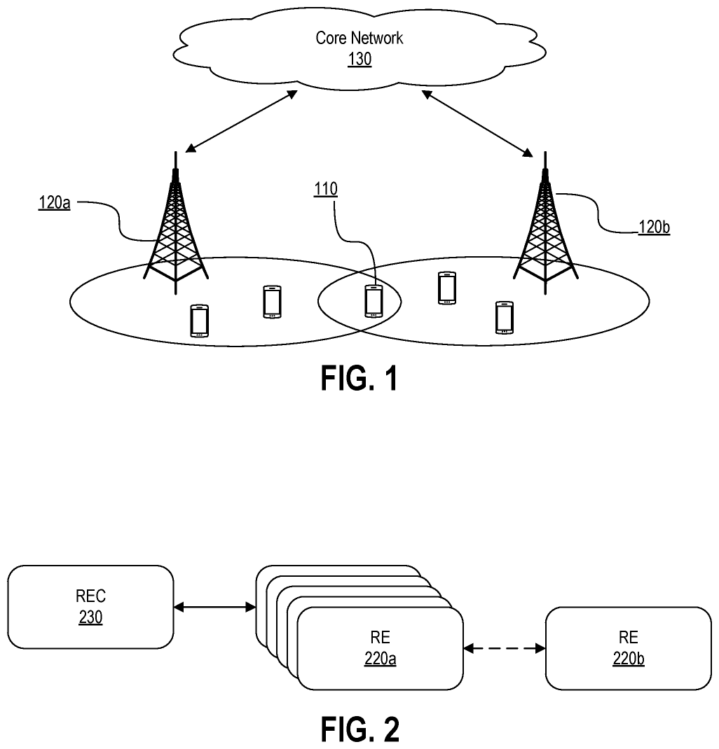

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

Traditional approaches for dealing with lossy media include forward error correction (“FEC”) and automatic repeat request (“ARQ”).

In FEC, the original message is modified prior to transmission (adding redundancy), and the receiver tries to recover the original data by post-processing the (possibly corrupted) received data. However, FEC-based methods may increase latency (if the decoder must operate over more than one packet) and computational complexity (e.g., to implement the decoding operation).

In ARQ, the receiver can request a retransmission if part (or the whole of) the original message is corrupted or not delivered. However, ARQ-based methods may not be suitable for applications such as fronthaul with very strict timing requirements.

In some examples, a scheme includes per-packet duplication that is removed at every hop in the network. The duplication step is coupled with a “redundancy elimination step”, where packet copies are encoded as references to the original packet in a cache. In additional or alternative examples, the spacing between an original packet and a copy can be tuned via a method's parameter. These examples can provide per-packet control over redundancy. However, while the second step of redundancy elimination provides smaller overhead (due to compression), it requires caches (and the associated decoding functionality) in each router to function.

In additional or alternative examples, each router in the path may select a packet (e.g., packet A), forward it and later forward compressed copies of packet A. If the next router in the path has already seen A, it will be able to decode the compressed copies. The compressed copies are expanded, put into a virtual queue, and may be dropped in case the router deems it necessary due to congestion (or queue management actions). Packets that survive queue management will be re-compressed prior to transmission towards the next hop.

Each router needs to implement the encoding/decoding of compressed packets and maintain a cache of ‘already seen’ packets, which demands special hardware and resources and introduces latency for the compression/decompression operation.

It is important to note that the routers are generally directed towards content distribution, which routinely delivers the same content to different hosts (e.g., streaming video content of a popular show), making it suitable for caching. It also must be said that the service being targeted is best-effort and delivered over the Internet.

These examples are not applicable for fronthaul for multiple reasons, including latency, need of special hardware, low likelihood of cache hits in a fronthaul application (content is not repeated) and no concept of timing restrictions. Furthermore, the procedure in these examples would not work in the event that the original packet is lost as it will not be possible to decompress the redundant packets without the original packet.

These examples may not cover spatial multiplexing. These examples may not cover on-demand redundancy. These examples may not cover the concept of scheduling under a transmit window timing constraint. These examples may not take advantage of synchronization between nodes (i.e., nodes cannot take actions based on their local timing and delay measurements). These examples may not cover any distinction between flows (such as control plane (“CP”), data plane (“DP”)) and provides no actions for the receiver as achieved by some embodiments described herein (i.e., buffering when CP message related to a DP flow is missing). Certain aspects of the disclosure and their embodiments may provide solutions to these or other challenges.

Various embodiments herein describe procedures for increasing robustness in functionally split base stations that are connected by a packet-based fronthaul. In some embodiments, the protection of control plane messages is increased by introducing controlled redundancy and spatial multiplexing while considering strict real-time deadlines imposed, for example, by intra-physical layer (“PHY”) splits.

In some embodiments, duplication of CP messages is introduced between a transmitting and receiving node in a fronthaul network. The scheduling of original and duplicated messages considers the one-way delay between nodes and the chosen path. At the receiver detection of CP losses is performed by detecting a DP flow that has no associated CP message yet. Detection of losses is informed from receiving node to transmitting node which then may increase redundancy. In additional or alternative embodiments, original and duplicated messages can be scheduled as well as actions to be taken by a receiving node in the absence of expected CP messages.

In some embodiments, procedures described herein improve a robustness of control plane messages in fronthaul networks. In some examples, this is achieved by controlled, on-demand duplication of specific CP messages. The duplication is performed taking into consideration the transmit window timings between fronthaul nodes and measurements (one-way delay) for each path (for a flexible definition of path) between the nodes. In additional or alternative embodiments, duplicates are scheduled over multiple paths respecting real-time constraints in fronthaul.

In some embodiments, procedures herein improve the robustness of fronthaul interfaces to losses of control plane messages (a single loss may cause a whole NR slot to be dropped). In additional or alternative embodiments, the procedures can be implemented with low complexity. In additional or alternative embodiments, nodes are expected to know the required transmit windows for normal operation. In additional or alternative embodiments, adding redundancy is only a copy operation. In additional or alternative embodiments, buffering is minimal (e.g., one maximum segment size (“MSS”)). In additional or alternative embodiments, no decoding operation is performed in the receiver. In additional or alternative embodiments, the procedure is flexible to cover multiple types of losses, from random frame check sequence (“FCS”) errors to losses in burst (e.g., by scheduling the copies randomly inside a transmit window). In additional or alternative embodiments, redundancy may be introduced only when necessary (e.g., after packet losses are detected by the receiving node). In additional or alternative embodiments, the procedure takes advantage of multiple paths between transmitting and receiving node to provide increased reliability (spatial diversity). In additional or alternative embodiments, the procedure can be implemented on traditional (wireline) or wireless fronthaul.

Some embodiments herein target a time-critical fronthaul application where the number of hops between the hosts (baseband and radio) is small (<=4), the latency and delay variation must be kept to a minimum and where switching equipment is foreseen to have shallow buffers. There is no allowance for packet caches in intermediate switches, no time for retransmission-based schemes.

Some embodiments herein can be implemented by endpoints (baseband and radio). In some examples, baseband and radio are synchronized (e.g., via precision time protocol (“PTP”) or other suitable method). In additional or alternative examples, delays for paths between baseband and radio can be measured (e.g., by a service provided by enhanced common public radio interface (“eCPRI”)).

In some embodiments, regarding redundancy, full copies of specific fronthaul control plane packets are transmit (as opposed to compressed copies of content). In additional or alternative embodiments, the redundancy is not indiscriminate or constant, but rather controlled and triggered by feedback from the receiving node (radio for downlink (“DL”), baseband for uplink (“UL”)).

In some embodiments, intermediate nodes (switches, routers) are not depended upon and no special functionality in those intermediate nodes is required. For example, the procedure may be fully implemented by hosts/endpoints.

In some embodiments, the redundant packets are triggered considering the deadlines for orthogonal frequency division multiplexing (“OFDM”) symbol boundaries (in time), processing requirements by baseband and radio (given by the transmit/receive window requirements) and one-way delay measurements of each path.

In some embodiments, redundant packets may be sent over multiple paths, according to each path's characteristics. This provides a degree of resiliency to path failures, congestion in specific paths.

In some embodiments, the procedure is transparent to the transport network infrastructure.

FIG. 2 illustrates an example of a fronthaul that communicatively couples a radio equipment controller (“REC”) 230 to a radio equipment (“RE”) 220b via one or more REs 220a. The arrow connecting REC 230 to RE 220a represents one or more packet-based links (a packet-based network). The RE 220a may be daisy-chained (dashed line) to RE 220b. Multiplexing nodes are not depicted but may be present. Links may represent wired (e.g., optical fiber, copper lines, coaxial cables, waveguides) or wireless connections (e.g., radio, visible light communication (“VLC”), free-space optics (“FSO”)).

A REC can include a baseband processing node, a baseband processing function (potentially virtualized), an eCPRI radio equipment controller (“eREC”), and/or an open radio access network (“O-RAN”) radio unit (“O-RU”) controller.

A RE can include a radio unit, a radio node, an eCPRI radio equipment (“eRE”), and/or an O-RU.

A Multiplexing node can include a switch, router, fronthaul multiplexer, eCPRI/CPRI interworking function, a networking function implementing a subset of fronthaul protocols, and/or an RE connected (e.g., in daisy chain mode) to another RE.

In some embodiments, the REC and the RE are connected by one or more network links (i.e., a network) and the communication between nodes is packet-based. Multiplexing nodes may connect any combination of REC and RE nodes. In some examples the functionality of a 3rd Generation Partnership Project (“3GPP”) compliant radio stack is implemented by the relevant nodes in complementary fashion (e.g., some functions are implemented at the REC and some functions at the RE, zero or more functions implemented by multiplexing nodes). In additional or alternative examples, there is a functional split in which the physical layer processing is divided between REC and RE. Examples of such functional splits includes the ones defined by 3GPP and O-RAN as well as other combinations of physical layer processing functions.

In additional or alternative embodiments, nodes are synchronized (e.g., share a common time reference) via appropriate means (e.g., PTP, global positioning system (“GPS”), and synchronous ethernet).

In additional or alternative embodiments, the REC and the RE exchange information (e.g., fronthaul traffic) using packets and the information exchange is time-critical (e.g., it must occur in real-time or near real-time). In some examples, the messages between REC and RE can be categorized into control (plane) messages and data (plane) messages.

The CP messages may include at least one of: component carrier identification; slot identification; beam identification; modulation indices; scaling factors; indices for mapping fronthaul information into physical resource blocks (“PRBs”); codebook indices; precoder indices for beamforming coefficients; bundling information; antenna power scaling information; and symbol ranges for beamform (“BF”) coefficient reuse.

The DP messages may include at least one of: modulated symbols; unmodulated symbols; transform coefficients; in-phase/quadrature (“IQ”) data; and beamforming coefficients.

In some embodiments, messages carry individual identifiers (e.g., it is always possible for the receiving node to distinguish a message, at least during the same transmit/receive window). It is further assumed that CP messages and DP messages may be associated via an identifier. An example is that a CP message may carry a transaction ID field while the DP messages (to which the CP message is relevant) carry the same transaction ID field.

In some embodiments, an RE (in DL) or an REC (in UL) may use the CP messages to arrange the data plane content in such a way that enable the transmission/reception of radio symbols (e.g., OFDM symbols). An example of such operation could be that the RE, having received control plane messages can interpret the following DP messages, arranging the contents of each message as binary words to be mapped to modulated symbols at the correct subcarrier indices and later perform OFDM modulation and transmission towards UEs in its coverage area. In this example, the absence of CP messages can cause the RE to not be able to generate a transmit symbol in the correct order and can cause performance degradation to the allocated UEs. Depending on the implementation, the performance degradation could affect one or more symbols or transmission opportunities.

In some embodiments, the CP messages are of utmost importance and guaranteed delivery is a goal.

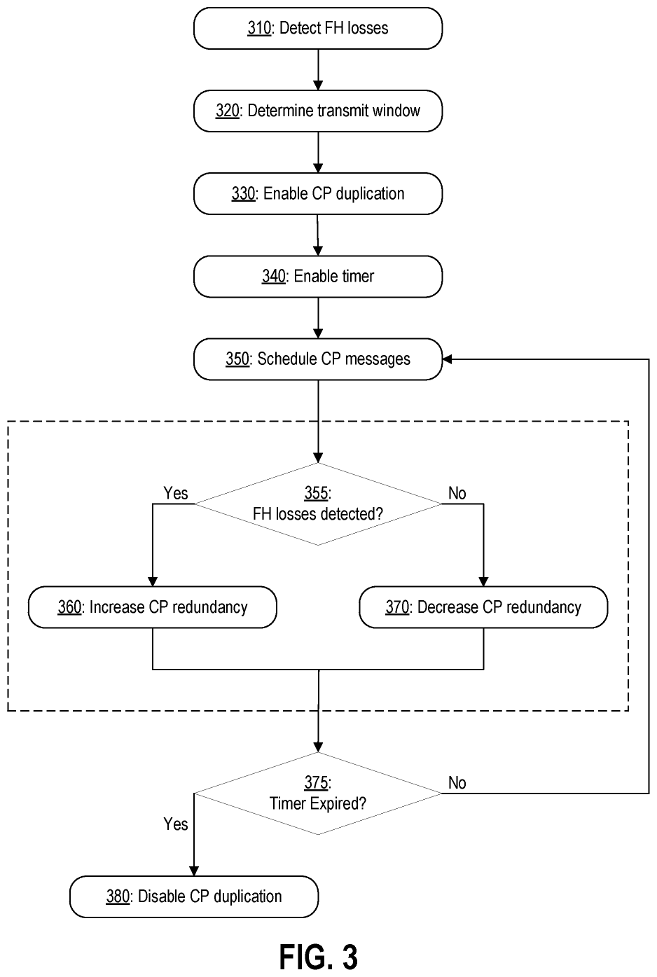

FIG. 3 illustrates an example of operations performed by a transmitting node according to some embodiments. The communication is assumed to be from an REC to an RE node, but the converse is also covered by the same procedures. The term transmitting node is used to identify a source of traffic (e.g., an REC, multiplexing node, or another RE may be the transmitting node).

At block 310, the transmitting node detects fronthaul (“FH”) losses. In some examples, the other operations in FIG. 3 are triggered by the detection of losses in fronthaul between the transmit and receiving nodes.

In some embodiments, detection may be performed by the receiving node and informed to the transmitting node. For example, the RE fails to receive a downlink control message within the duration of its receiving window and then notifies the REC via an urgent eCPRI message.

In additional or alternative embodiments, detection may be realized by the transmitting node autonomously. For example, the REC detects negative acknowledgements (“NACKs”) from all UEs scheduled in a slot, REC detects low beamforming gain from all scheduled UEs in a slot).

In additional or alternative embodiments, detection may be further achieved by inspection of message sequence numbers (missing sequence numbers indicate lost messages). A multiplexing node may inform the transmitting node of such losses.

In additional or alternative embodiments, losses in the DP may be used to trigger the operations as a precautionary measure.

At block 320, the transmitting node determines a transmit window. In some examples, the transmitting node obtains the start and end of its own transmit window (e.g., the interval over which it can transmit CP messages towards the receiving node for an upcoming transmit opportunity).

In some embodiments, the start of the transmit window tₛ may be calculated as

$${t}_{s} = {t}_{s r x} - {d}_{tr} ,$$

where dₜᵣ is the one-way delay from transmitting to receiving node, and tₛᵣₓ is the earliest time prior to the over-the-air transmit deadline when the receiving node can receive data or control plane messages.

In some examples, dₜᵣ may be obtained by measurement between the nodes. In additional or alternative examples, dₜᵣ may also be a fixed parameter, determined at network planning or configured to the transmitting node. In additional or alternative examples, dₜᵣ may be obtained from a latency bound offered by a wireless link or a latency bound associated with a flow in a network that offer such guarantees.

In some examples, tₛᵣₓ may be determined by the receiving node and informed to the transmitting node. It may be signaled as an offset to over-the-air symbol transmission deadline (e.g., a reception deadline for RE to REC communication). It may be constant or variable. Its definition may consider the buffering and processing capabilities of the receiving node.

In some embodiments, the end of the transmit window tₑ may be calculated as

$${t}_{e} = {t}_{e r x} - {d}_{tr} ,$$

where tₑᵣₓ is the latest time before the over-the-air transmit deadline where the receiving node can receive CP messages. In some examples, tₑᵣₓ is determined by the receiving node and informed to the transmitting node (e.g., at initialization, initial pairing).

In defining tₑᵣₓ, the receiving node may consider its buffering capability. If CP messages are not delivered prior to the data plane messages they refer to, the receiving node must buffer the DP content until the relevant CP information is delivered or the transmit deadline arrives. tₑᵣₓ may be further constrained if the receiving node takes its processing time into consideration. Buffering of DP messages may be selective (e.g., buffer only prioritized data, such as physical downlink control channel (“PDCCH”) content).

At block 330, the transmitting node enables CP duplication. In some examples, the transmitting node obtains the redundancy factor (an integer indicating the degree of duplication to be applied per CP message). The initial redundancy factor may be obtained from configuration parameters, obtained at initialization or from a network management function (e.g., Service Management and Orchestration (“SMO”), Software Defined Networking (“SDN”) controller, Network Management System (“NMS”)).

In some embodiments, the transmitting node may notify the receiving node (as well as any node in the path towards the receiving node) that CP duplication is activated. The notification messages may include the redundancy factor.

At block 340, the transmitting node enables a timer. In some examples, the timer is initiated over which CP duplication will be performed. The operations in blocks 350, 355, 360, and 370 can then be repeated for each transmit opportunity while the timer has not expired. In some examples, the timer counts time intervals. In additional or alternative examples, the timer counts radio symbols, transmit opportunities, or message exchanges.

At block 350, the transmitting node schedules the CP messages. In some examples, the transmitting node produces duplicates of at least one CP message and triggers its transmission inside of its transmit window, obtained in block 320. The redundancy factor obtained in block 330 can control how many copies shall be produced (e.g., 2 or 3). Copies of the CP message may be scheduled to be transmit in a burst during the transmit window, uniformly distributed over the transmit window, or randomly distributed over the transmit window.

In some embodiments, the CP message is scheduled to be transmit in a burst of copies of the same message. In additional or alternative embodiments, the copies of the CP message are transmitted in sequence, with minimum gap between them. A burst could, for example, be scheduled close to the end of the transmit window.

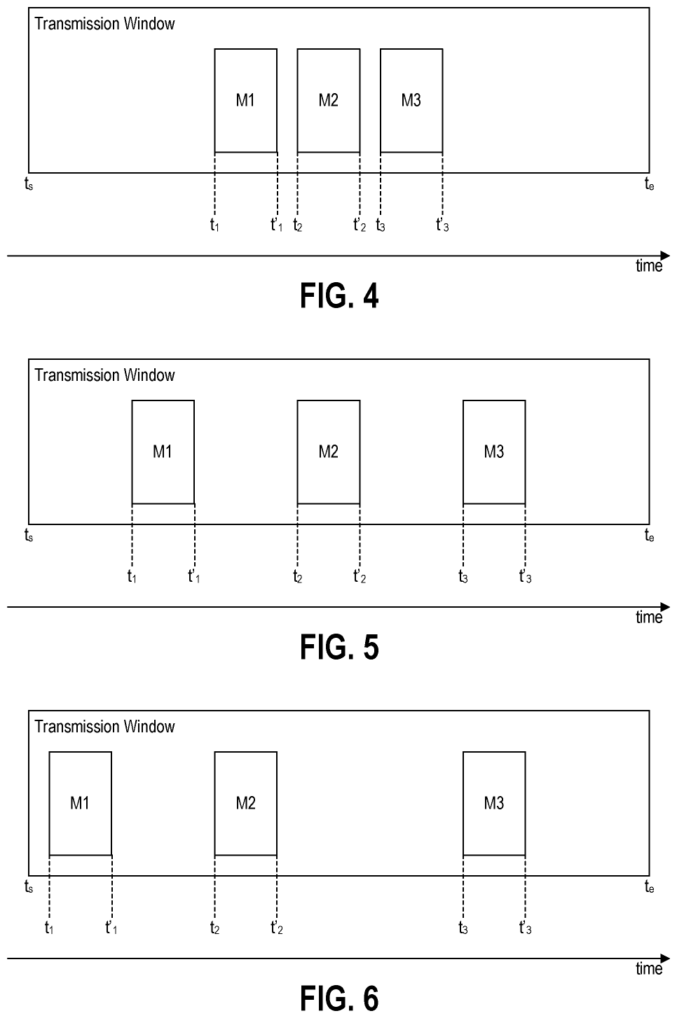

FIG. 4 illustrates an example of duplicate CP messages being transmitted in a burst mode. M1 represents the original message, while M2 and M3 represent copies. tₛ, tₑ represent the start and end of the transmission window. Start and end times for a message transmission are represented by tᵢ, t′ᵢ respectively. In this mode the gap between copies tᵢ₊ᵢ−t′ᵢ is made as small as possible.

In some embodiments, copies of a CP message are spread out inside the transmit window, with a constant gap between them. FIG. 5 illustrates an example of duplicate CP messages transmitted in a uniform mode. M1 represents the original message, while M2 and M3 represent copies. tₛ, tₑ represent the start and end of the transmission window. Start and end times for a message transmission are represented by tᵢ, t′ᵢ respectively. In this mode the gap between copies tᵢ₊ᵢ-t′ᵢ is the same for all i≥1.

In some embodiments, copies of a CP message have a random gap between them. FIG. 6 illustrates an example of duplicate CP messages transmitted in a random mode. M1 represents the original message, while M2 and M3 represent copies. tₛ, tₑ represent the start and end of the transmission window. Start and end times for a message transmission are represented by tᵢ, t′ᵢ respectively. In this mode the gap between copies tᵢ₊ᵢ-t′ᵢ is chosen at random.

In some embodiments, an implementer may choose to apply a different set of actions according to the sensitivity of the CP message (e.g., duplicate symbol map messages, RAN scheduling information, while not duplicating beamforming control information).

In some examples, the CP duplication as stated above refers to the content of a CP message. The implementing nodes are free to apply transformations to the message (e.g., encapsulation) to adapt it to the underlying characteristics of the transport network. An example is that a CP message and a duplicate CP message may be encoded/encapsulated differently (e.g., different forward error correction (“FEC”) encoding parameters by lower layers, different redundancy bits). A second example is that the CP message and the duplicate CP message may be sent using a different virtual local area network (“VLAN”) tag.

In some embodiments, the CP duplication may be combined with spatial diversity (e.g., messages can be sent through different paths towards the receiver). The duplication pattern may be applied in the same manner over multiple paths or an arbitrary mapping of message to a path could be used. The mechanisms for spatial duplication are assumed to be available to the transmitting nodes (e.g., source routing).

As an example, messages M1, M2, M3 in any of FIGS. 4-6 could be sent by distinct paths from transmitting node to receiving node. Furthermore, the transmitting node may adjust the gap between messages tᵢ₊ᵢ-tᵢ considering the one-way delay between transmit and receiving node for a given path. This allows for schemes such as simultaneous delivery of a message via independent paths towards the receiver.

Further examples of diversity include mapping messages to different packet flows (e.g., with another VLAN tag, other flow identifier). Alternatively, path diversity may refer to transmission of the messages over different bands, carriers, beams (spatial streams) or code domain.

Returning to FIG. 3, at block 355, the transmitting node determines whether any FH losses are detected. If after initiating the timer, the transmitting node still detects (or is informed of) continued losses, then at block 360, the redundancy for CP messages can be increased (higher redundancy factor). Alternatively, if after initiating the timer, the transmitting node cannot detect further losses, then at block 370, the redundancy for CP messages can be decreased (lower redundancy factor). If after decreasing the redundancy factor, only the original messages are transmitted, further occurrences of this operation have no practical effects. In some examples, the transmitting node may initiate CP duplication in response to detecting a first loss by setting the redundancy factor to two, which may indicate that two CP messages be transmit (the original and 1 duplicates) toward the receiving node. In additional or alternative examples, the transmitting node may increase the redundancy factor to three, which may indicate that three CP message be transmit (the original and 2 duplicates) toward the receiving node in response to detecting a second loss. The second loss may be a loss that occurs while the redundancy factor is two (e.g., while the transmitting node is transmitting two of every CP message).

At block 375, the transmitting node determines whether the timer (enabled in block 340) has expired. If not, the transmitting node continues scheduling CP message duplicates. Once the timer expires, duplication is interrupted, and the transmitting node reverts to the default behavior (no duplication of CP messages) (block 380).

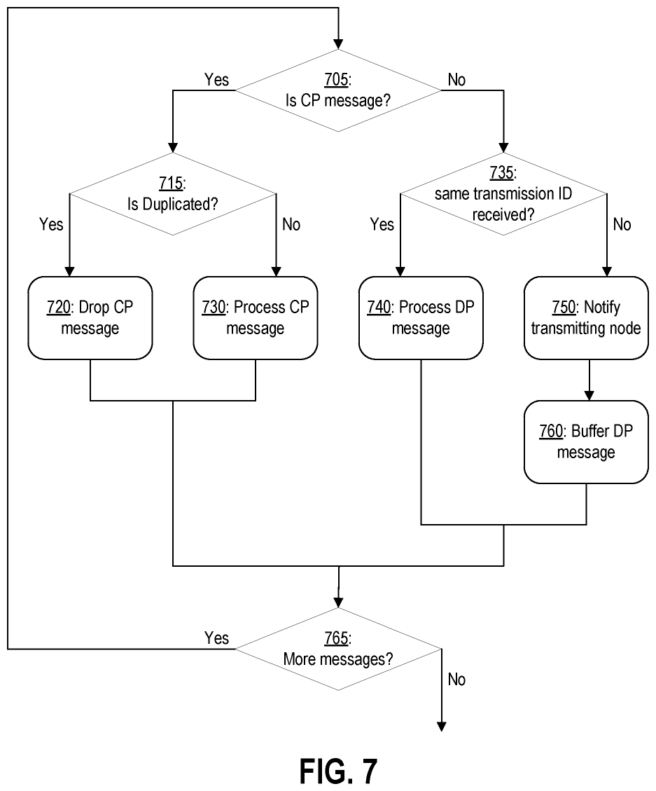

FIG. 7 illustrates an example of operations performed by a receiving node according to some embodiments. When CP duplication is active, it is important that the receiving node can properly deal with the duplicated CP messages. The illustrated operations allow that duplicated CP messages be silently dropped by the receiving node. Dropping may be implemented in any layer of the receiving node networking stack. Additionally, the comparison and dropping may be hardware accelerated.

At block 705, the receiving node determines whether a received message is a CP message (e.g., rather than a DP message). If the receiving node determines that the received message is a CP message, the receiving node proceeds to perform the operations of block 715. Otherwise, the receiving node proceeds to perform the operations of block 735.

At block 715, the receiving node determines whether the CP message is a duplicate message. If the receiving node determines that the CP message is a duplicate message, the receiving node drops the CP message (block 720). Otherwise, the receiving node processes the CP message (block 730).

In some embodiments, the receiving node determines whether the CP message is a duplicate message by comparing message identifiers. For example, if a message is received with the same identifier (e.g., sequence number) for the same receiving window, the message is determined to be a duplicate message (and should be dropped).

In additional or alternative embodiments, the receiving node determines whether the CP message is a duplicate message by calculating a hash of a subset of fields in the message payload. For example, if one or more of the payload fields in the CP message may be used to identify the message then if a match is found during the same receiving window, the message is determined to be a duplicate message (and should be dropped).

At block 735, the receiving node determines whether a transmission ID of the received message (e.g., a DP message) is the same as transmission ID of a CP message that was previously received. If the transmission ID of the received message is the same as a transmission ID of a previously received CP message, then the receiving node processes the DP message (block 740). Otherwise, the receiving node notifies the transmitting node that a DP message has been received prior to a corresponding CP message (block 750) and buffers the DP message (block 760).

In some embodiments, while processing DP messages, the receiving node may inspect the transaction identifier and compare to its knowledge of the last (or last-N) transaction identifier field(s) seem in CP messages. If a DP message is received with a transaction identifier to which an associated CP message has not yet been delivered, the receiving node shall notify the transmitting node immediately. DP messages shall not be dropped but buffered instead. The implementer may apply some policy on what to buffer. For example, the receiving node may be configured to only buffer high priority DP messages (e.g., PDCCH messages).

At block 765, the receiving node may determine whether there are more messages (CP messages or DP messages). If there are more messages, the receiving node may return to performing the operation of block 705 (and the corresponding subsequent operations) for each message.

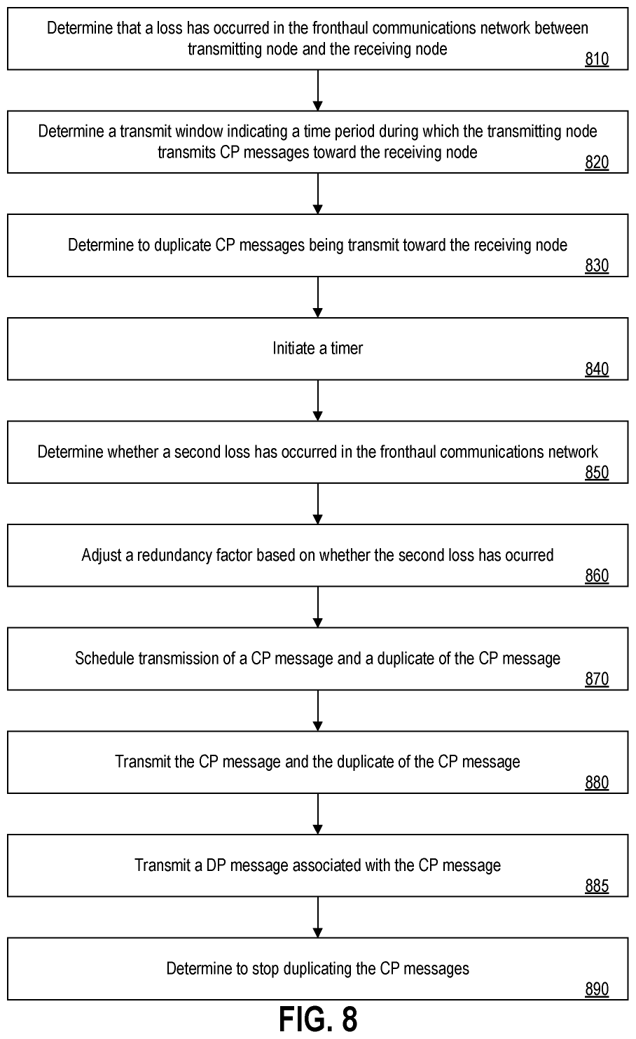

In the description that follows, while the transmitting node may be any of REC 230, RE 220a-b, CN Node 1008, Network Node 1010A-B, 1200, hardware 1404, or virtual machine 1408A, 1408B, the network node 1200 shall be used to describe the functionality of the operations of the transmitting node. Operations of the network node 1200 (implemented using the structure of FIG. 12) will now be discussed with reference to the flow chart of FIG. 8 according to some embodiments of inventive concepts. For example, modules may be stored in memory 1210 of FIG. 12, and these modules may provide instructions so that when the instructions of a module are executed by respective network node processing circuitry 1202, processing circuitry 1202 performs respective operations of the flow chart.

FIG. 8 illustrates an example of operations performed by a transmitting node in a fronthaul communications network that includes a receiving node.

At block 810, processing circuitry 1202 determines that a loss has occurred in the fronthaul communications network between the transmitting node and the receiving node. In some embodiments, determining that the loss has occurred includes receiving an indication of the loss from the receiving node. In additional or alternative embodiments, determining that the loss has occurred includes determining that a control message (e.g., a first CP message transmitted prior to determining that the loss has occurred. failed to reach the receiving node within a predetermined time period (e.g., a transmit window).

At block 820, processing circuitry 1202 determines a transmit window indicating a time period during which the transmitting node transmits CP messages towards the receiving node. In some embodiments, determining the transmit window includes determining the transmit window based on at least one of: a one-way delay, dₜᵣ, from the transmitting node to the receiving node; an earliest time, tₛᵣₓ, prior to the over-the-air transmit deadline when the receiving node can receive the CP messages; and a latest time, tₑᵣₓ, before the over-the-air transmit deadline when the receiving node can receive the CP messages. In additional or alternative embodiments, determining the transmit window includes determining a start of the transmit window, tₛ, equals tₛᵣₓ−dₜᵣ and determining an end of the transmit window, tₑ, equals tₑᵣₓ−dₜᵣ.

At block 830, processing circuitry 1202 determines to duplicate CP messages being transmitted toward the receiving node. In some embodiments, determining to duplicate the CP messages includes determining to duplicate the CP messages based on a redundancy factor.

At block 840, processing circuitry 1202 initiates a timer.

At block 850, processing circuitry 1202 determines whether a second loss has occurred in the fronthaul communications network.

At block 860, processing circuitry 1202 adjusts a redundancy factor based on whether the second loss has occurred.

At block 870, processing circuitry 1202 schedules transmission of a CP message and a duplicate of the CP message. In some embodiments, scheduling transmission of the CP message and the duplicate of the CP message includes scheduling transmission of the CP message toward the receiving node via a first path through the fronthaul communications network and scheduling transmission of the duplicate CP message toward the receiving node via a second path through the fronthaul communications network.

In additional or alternative embodiments, scheduling transmission of the CP message and the duplicate of the CP message includes determining the first path and the second path based on at least one of: a redundancy factor; a priority of a communication device associated with the CP message; and a priority of a data plane, DP, message associated with the CP message.

In some examples, the first path through the fronthaul communications network is the same as the second path through the fronthaul communications network. In other examples, the first path through the fronthaul communications network is different than the second path through the fronthaul communications network.

In additional or alternative embodiments, determining to duplicate the CP messages includes determining a number of duplicates of each of the CP messages to transmit toward the receiving node based on a redundancy factor. Scheduling transmission of the CP message and the duplicate of the CP message can include scheduling transmission of the CP message and each duplicate of the CP message toward the receiving node.

In additional or alternative embodiments, the duplicate of the CP message includes one or more duplicates of the CP message. In some examples, scheduling transmission of the CP message and the duplicate of the CP message includes scheduling a burst transmission of the CP message and the one or more duplicates of the CP message within the transmission window. In additional or alternative examples, scheduling transmission of the CP message and the duplicate of the CP message includes uniformly distributed transmissions of the CP message and the one or more duplicates of the CP message across the transmission window. In additional or alternative examples, scheduling transmission of the CP message and the duplicate of the CP message includes randomly distributed transmissions of the CP message and the one or more duplicates of the CP message across the transmission window.

In additional or alternative embodiments, the transmitting node includes a radio equipment controller, REC, and the receiving node includes a radio equipment, RE. Scheduling transmission of the CP message and the duplicate of the CP message includes scheduling downlink transmission of the CP message and the duplicate of the CP message.

In additional or alternative embodiments, the transmitting node includes a radio equipment, RE, and the receiving node includes a radio equipment controller, REC. Scheduling transmission of the CP message and the duplicate of the CP message includes scheduling uplink transmission of the CP message and the duplicate of the CP message.

At block 880, processing circuitry 1202 transmits, via communication interface 1206, the CP message and the duplicate of the CP message toward the receiving node.

At block 885, processing circuitry 1202 transmits, via communication interface 1206, a DP message associated with the CP message toward the receiving node.

At block 890, processing circuitry 1202 determines to stop duplicating the CP messages. In some examples, processing circuitry 1202 determines to stop duplicating the CP message in response to expiration of the timer (initialized in block 840).

Various operations of FIG. 8 may be optional with respect to some embodiments. In some examples, blocks 820, 840, 850, 860, 880, 885, and 890 are optional.

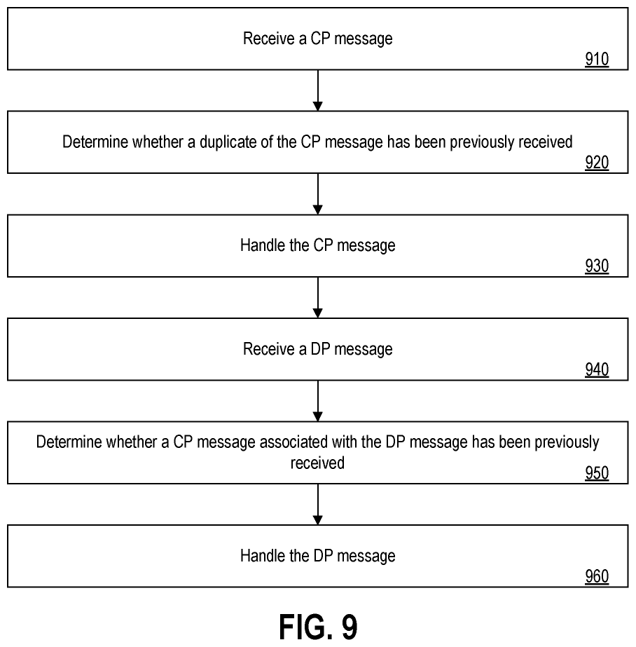

In the description that follows, while the receiving node may be any of REC 230, RE 220a-b, CN Node 1008, Network Node 1010A-B, 1200, hardware 1404, or virtual machine 1408A, 1408B, the network node 1200 shall be used to describe the functionality of the operations of the transmitting node. Operations of the network node 1200 (implemented using the structure of FIG. 12) will now be discussed with reference to the flow chart of FIG. 9 according to some embodiments of inventive concepts. For example, modules may be stored in memory 1210 of FIG. 12, and these modules may provide instructions so that when the instructions of a module are executed by respective network node processing circuitry 1202, processing circuitry 1202 performs respective operations of the flow chart.

FIG. 9 illustrates an example of operations performed by a receiving node in a fronthaul communications network that includes a transmitting node.

At block 910, processing circuitry 1202 receives, via communication interface 1206, a CP message from the transmitting node.

In some embodiments, the transmitting node includes a radio equipment controller, REC, and the receiving node includes a radio equipment, RE. Receiving the CP message includes receiving a downlink CP message from the transmitting node.

In additional or alternative embodiments, the transmitting node includes a radio equipment, RE, and the receiving node includes a radio equipment controller, REC. Receiving the CP message includes receiving an uplink CP message from the transmitting node.

At block 920, processing circuitry 1202 determines whether a duplicate of the CP message has been previously received. In some embodiments, determining whether the duplicate of the CP message has previously been received includes determining whether the duplicate of the CP message has previously been received during a current reception window.

In additional or alternative embodiments, receiving the CP message includes receiving the CP message via a first path through the fronthaul communications network. Determining whether the duplicate of the CP message has previously been received includes determining whether the duplicate of the CP message has previously been received via a second path through the fronthaul communications network.

At block 930, processing circuitry 120 handles the CP message based on whether the duplicate of the CP message has been previously received. In some embodiments, the duplicate of the CP message has previously been received and handling the CP message includes dropping the CP message.

In additional or alternative embodiments, the duplicate of the CP message has not previously been received and handling the CP message includes processing the CP message.

At block 940, processing circuitry 1202 receives, via communication interface 1206, a DP message from the transmitting node.

At block 950, processing circuitry 1202 determines whether a CP message associated with the DP message has been previously received. In some embodiments, determining whether the CP message associated with the DP message has been previously received by the receiving node includes determining whether any previously received CP messages have a transmission identifier (“ID”) matching the DP message. In additional or alternative embodiments, determining whether the CP message associated with the DP message has been previously received by the receiving node includes determining whether a hash of a subset of fields in a message payload of any previously received CP messages match the DP message.

In additional or alternative embodiments, determining whether the second CP message associated with the DP message has been previously received by the receiving node includes determining whether the second CP message associated with the DP message has been previously received by the receiving node during a current receiving window.

At block 960, processing circuitry 1202 handles the DP message based on whether the CP message associated with the DP message has been previously received. In some embodiments, the second CP message associated with the DP message has been previously received by the receiving node and handling the DP message includes processing the DP message.

In additional or alternative embodiments, the second CP message associated with the DP message has not been previously received by the receiving node. In some examples, handling the DP message includes transmitting a signal to the transmitting node indicating that the second CP message has been lost. In additional or alternative examples, handling the DP message includes storing the DP message in a buffer for a predetermined period of time (e.g., the current receiving window).

Various operations of FIG. 9 may be optional with respect to some embodiments. In some examples, blocks 940, 950, and 960 are optional. In other examples, blocks 910, 920, and 930 are optional.

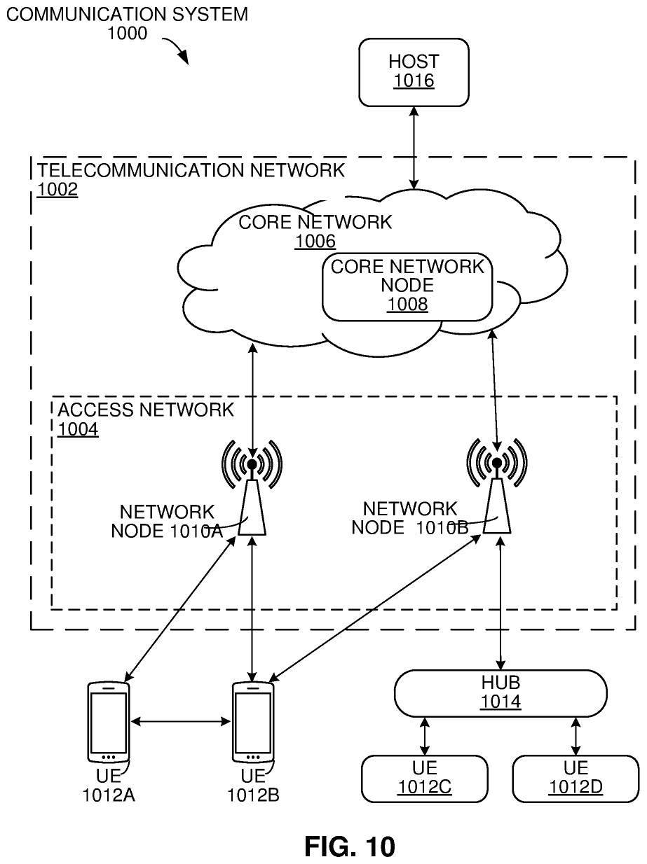

FIG. 10 shows an example of a communication system 1000 in accordance with some embodiments.

In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3rd Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

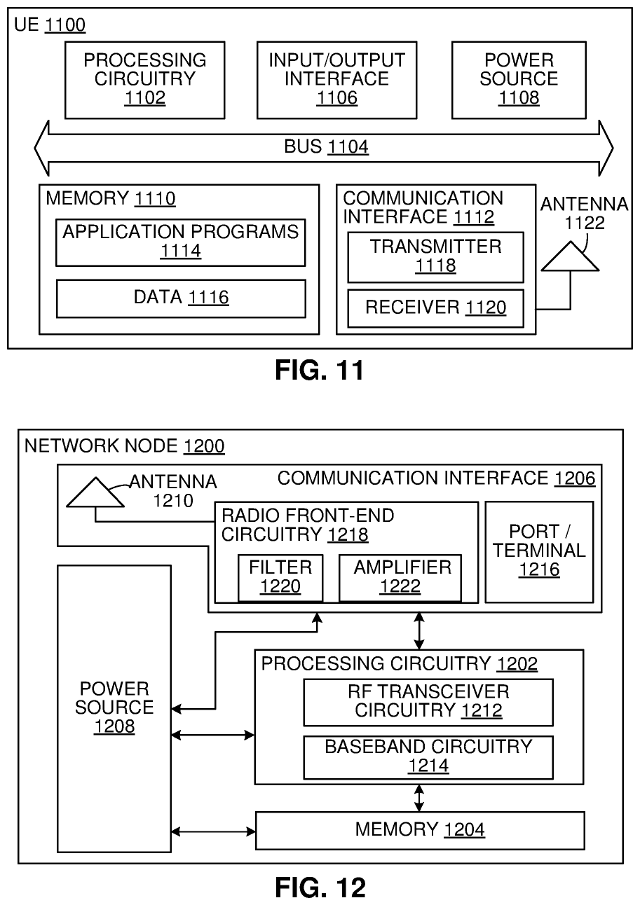

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

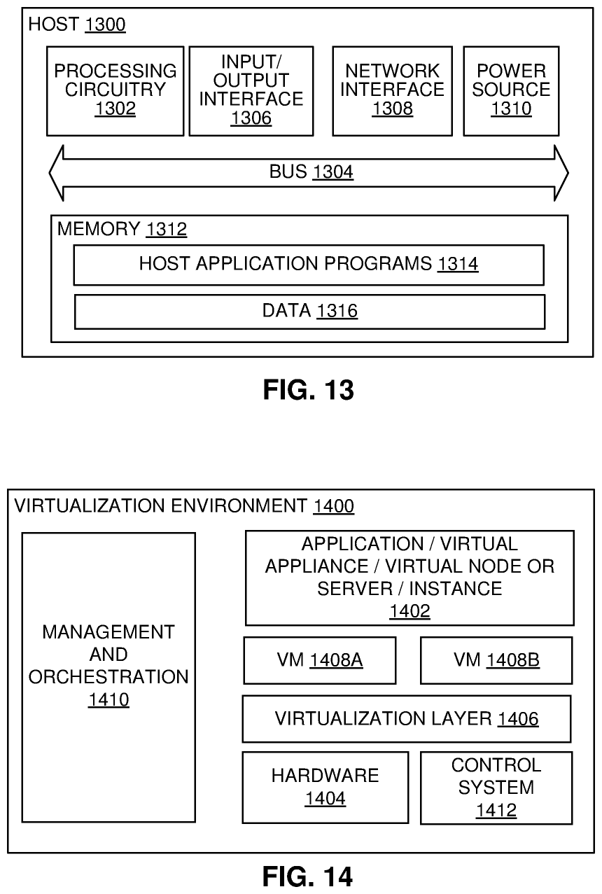

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11-12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment 1400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

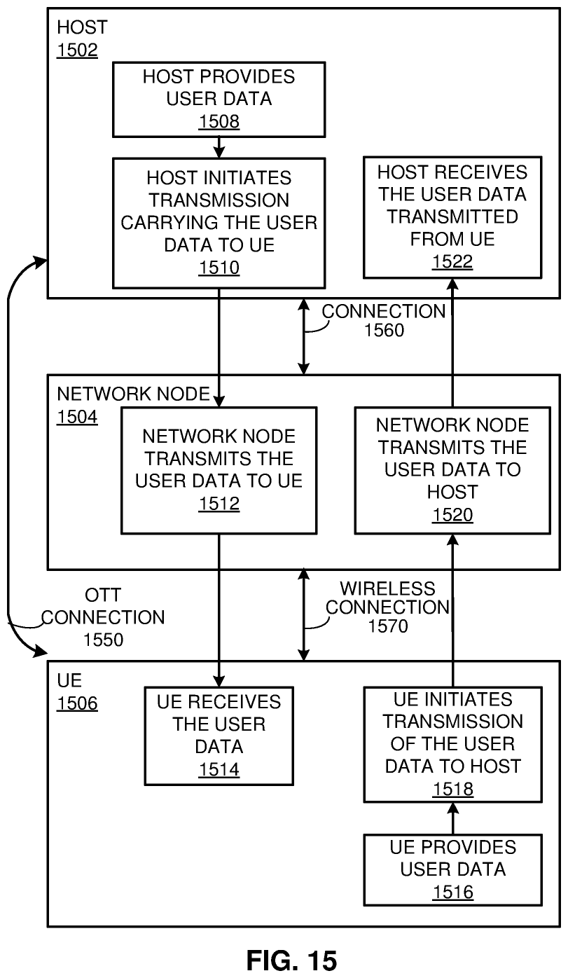

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1200 of FIG. 12) discussed in the preceding paragraphs will now be described with reference to FIG. 15.

Like host 1200, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. More precisely, the teachings of these embodiments may improve the robustness of fronthaul interfaces to losses of CP messages.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method of operating a transmitting node in a fronthaul communications network that includes a receiving node, the method comprising:
determining that a loss has occurred in the fronthaul communications network between the transmitting node and the receiving node;
responsive to determining that the loss has occurred, determining to duplicate control plane, CP, messages being transmitted toward the receiving node; and
scheduling transmission of a CP message and a duplicate of the CP message toward the receiving node.

2. The method of claim 1, wherein determining that the loss has occurred comprises receiving an indication of the loss from the receiving node.

3. The method of claim 1, wherein the CP message comprises a second CP message, and wherein determining that the loss has occurred comprises determining that a first CP message transmitted by the transmitting node toward the receiving node failed to reach the receiving node within a predetermined time period, the first CP message having been transmitted prior to the second CP message and prior to determining that the loss has occurred.

4. The method of claim 1, wherein determining to duplicate the CP messages comprises determining to duplicate the CP messages based on a redundancy factor, and wherein the loss comprises a first loss, the method further comprising:
determining whether a second loss has occurred in the fronthaul communications network between the transmitting node and the receiving node; and
responsive to determining whether the second loss has occurred, adjusting the redundancy factor based on whether the second loss has occurred.

5. The method of claim 1, wherein scheduling transmission of the CP message and the duplicate of the CP message comprises:
scheduling transmission of the CP message toward the receiving node via a first path through the fronthaul communications network;
scheduling transmission of the duplicate CP message toward the receiving node via a second path through the fronthaul communications network; and
determining the first path and the second path based on at least one of:
a redundancy factor;
a priority of a communication device associated with the CP message; and
a priority of a data plane, DP, message associated with the CP message.

6. (canceled)

7. The method of claim 5, wherein the first path through the fronthaul communications network is different than the second path through the fronthaul communications network.

8. The method of claim 1, wherein determining to duplicate the CP messages being transmitted toward the receiving node comprises determining a number of duplicates of each of the CP messages to transmit toward the receiving node based on a redundancy factor, and wherein scheduling transmission of the CP message and the duplicate of the CP message comprises scheduling transmission of the CP message and each duplicate of the CP message toward the receiving node.

9. The method of claim 1, further comprising:
determining a transmit window indicating a time period during which the transmitting node transmits the CP messages toward the receiving node, wherein determining the transmit window comprises determining the transmit window based on at least one of:
a one-way delay, dₜᵣ, from the transmitting node to the receiving node;
an earliest time, tₛᵣₓ, prior to the over-the-air transmit deadline when the receiving node can receive the CP messages; and
a latest time, tₑᵣₓ, before the over-the-air transmit deadline when the receiving node can receive the CP messages.

10. (canceled)

11. The method of claim 9, wherein determining the transmit window comprises:
determining a start of the transmit window, tₛ, equals tₛᵣₓ−dₜᵣ; and
determining an end of the transmit window, tₑ, equals tₑᵣₓ−dₜᵣ.

12. The method of claim 9, wherein the duplicate of the CP message comprises one or more duplicates of the CP message, and wherein scheduling transmission of the CP message and the duplicate of the CP message comprises scheduling at least one of:
a burst transmission of the CP message and the one or more duplicates of the CP message within the transmission window.
uniformly distributed transmissions of the CP message and the one or more duplicates of the CP message across the transmission window; and
randomly distributed transmissions of the CP message and the one or more duplicates of the CP message across the transmission window.

13. The method of claim 1, further comprising:
transmitting the CP message and the duplicate of the CP message toward the receiving node; and
transmitting a DP message associated with the CP message toward the receiving node.

14. The method of claim 1, further comprising:
responsive to determining to duplicate the CP messages, initiating a timer; and
responsive to expiration of the timer, determining to stop duplicating the CP messages.

15. The method of claim 1, wherein the transmitting node comprises a radio equipment controller, REC,
wherein the receiving node comprises a radio equipment, RE, and
wherein scheduling transmission of the CP message and the duplicate of the CP message comprises scheduling downlink transmission of the CP message and the duplicate of the CP message.

16. The method of claim 1, wherein the transmitting node comprises a radio equipment, RE, wherein the receiving node comprises a radio equipment controller, REC, and wherein scheduling transmission of the CP message and the duplicate of the CP message comprises scheduling uplink transmission of the CP message and the duplicate of the CP message.

17. A method of operating a receiving node in a fronthaul communications network that includes a transmitting node, the method comprising:
receiving a control plane, CP, message from the transmitting node;
determining whether a duplicate of the CP message has previously been received by the receiving node; and
responsive to determining whether the duplicate of the CP message has previously been received, handling the CP message based on whether the duplicate of the CP message has previously been received.

18.-20. (canceled)

21. The method of claim 17, wherein receiving the CP message comprises receiving the CP message via a first path through the fronthaul communications network, and wherein determining whether the duplicate of the CP message has previously been received comprises determining whether the duplicate of the CP message has previously been received via a second path through the fronthaul communications network.

22. The method of claim 17, wherein the CP message comprises a first CP message, the method further comprising:
receiving a data plane, DP, message from the transmitting node;
determining whether a second CP message associated with the DP message has been previously received by the receiving node; and
handling the DP message based on whether the second CP message has been previously received.

23.-25. (canceled)

26. The method of claim 22, wherein the second CP message associated with the DP message has not been previously received by the receiving node, and wherein handling the DP message comprises at least one of:
transmitting a signal to the transmitting node indicating that the second CP message has been lost; and
storing the DP message in a buffer for a predetermined period of time.

27. A method of operating a receiving node in a fronthaul communications network that includes a transmitting node, the method comprising:
receiving a data plane, DP, message from the transmitting node;
determining that a control plane, CP, message associated with the DP message has not been previously received by the receiving node;
transmitting a signal to the transmitting node indicating that the CP message has been lost; and
storing the DP message in a buffer for a predetermined period of time.

28.-30. (canceled)

31. A transmitting node, the transmitting node comprising:
processing circuitry; and
memory coupled to the processing circuitry and having instructions stored therein that are executable by the processing circuitry to cause the transmitting node to perform operations comprising:
determining that a loss has occurred in the fronthaul communications network between the transmitting node and a receiving node;
responsive to determining that the loss has occurred, determining to duplicate control plane, CP, messages being transmitted toward the receiving node; and
scheduling transmission of a CP message and a duplicate of the CP message toward the receiving node.

32.-36. (canceled)
